(19) United States
(12) Patent Application Publication
(10) Pub. No.: US 2016/0161966 A1
(43) Pub. Date: Jun. 9, 2016

(54) APPARATUS FOR CHARGEABLE ELECTRICAL DEVICE AND/OR ELECTRICAL DEVICE, AND ELECTRICAL GRID

(71) Applicants: Lahav Gil, Toronto (CA); Igal Roytblat, Richmond Hill (CA); Philipp Stucklin, Toronto (CA)

(72) Inventors: Lahav Gil, Toronto (CA); Igal Roytblat, Richmond Hill (CA); Philipp Stucklin, Toronto (CA)

(21) Appl. No.: 14/957,811

(22) Filed: Dec. 3, 2015

Related U.S. Application Data
(60) Provisional application No. 62/087,934, filed on Dec. 5, 2014.

(51) Int. Cl. G05F 1/66; G06Q 40/00; H02J 7/00

(52) U.S. Cl. CPC G05F 1/66; H02J 7/0052; G06Q 40/12

(57) ABSTRACT

In accordance with an example, an apparatus is for any one of a chargeable electrical device and an electrical device each. The chargeable electrical device and/or and the electrical device are each configured to be plugged into, and to receive power from, an electrical grid. The electrical grid is configured to provide electrical energy in accordance with any one of the electrical energy pricing and electricity availability. The apparatus includes (and is not limited to) a combination of the first control unit and the second control unit.

### RELATED APPLICATIONS

This application claims priority from U.S. Provisional Application No. 62/087,934, filed Dec. 5, 2014, the entirety of which is incorporated herein by reference.

### TECHNICAL FIELD

Some aspects generally relate to (and are not limited to) an apparatus for any one of a chargeable electrical device and an electrical device, and an electrical grid (and a method thereof).

### BACKGROUND

Electrical energy is a fundamental resource to modern civilization. As the world's population and the use of electrical devices increase, so does the overall need for on-demand electrical supply. In consequence, more power plants are being built and distribution infrastructure is upgraded to respond to the increased demand for electricity and to prevent failures of the existing electrical distribution networks during peak demand times.

### SUMMARY

It will be appreciated there exists a need to mitigate (at least in part) at least one problem associated with existing systems for powering a chargeable electrical device. After much study of the known systems and methods with experimentation, an understanding of the problem and its solution has been identified and is articulated as follows:

A problem is that there are undesirable and/or unnecessary loads applied to the electrical grid when electrical devices and/or chargeable electrical devices are connected to the electrical grid.

A problem associated with using a chargeable electrical device (also called, a chargeable) is the cost of operation of the chargeable electrical device. The chargeable electrical device is an electrical device (such as a cellular phone, a laptop computer, etc.) that includes a chargeable battery assembly. The chargeable electrical device is normally powered (operated) by the chargeable battery assembly. However, when the chargeable battery assembly becomes depleted, the chargeable battery assembly is recharged by being plugged into an electrical wall socket (an electrical outlet or a point of connection to the electrical grid), and may then become recharged accordingly.

In terms of energy use, peak demand describes a period of simultaneous, strong consumer demand or a period of highest demand in a billing period. Peak demand, peak load or on-peak are terms used in energy demand management describing a period in which electrical power is expected to be provided for a sustained period at a significantly higher than average supply level. During times of peak demand for the electrical grid, the cost of electricity is relatively higher. Peak demand is considered the opposite of off-peak hours when power demand is usually low (and therefore cost of electricity is relatively lower).

Nowadays more and more chargeable electrical devices are equipped with a chargeable battery assembly configured to permit the chargeable electrical devices to function for extended periods without constant connection to the power grid. While the chargeable electrical device does not necessarily need to be recharged during peak hours, this is often done by individual users. Some users leave their chargeable electrical devices continuously connected to the electrical outlet, and are unaware of the stress the cumulative effect inflicted on the distribution network (electrical grid) (even more so during times of peak demand).

There appears to be no system (solution) that specifically addresses shifting the power consumption of chargeable electrical devices away from the peak hours (time of peak demand of the electrical grid) in an efficient and cost-effective way. The reason is believed to be that most chargeable electrical devices are low-power devices that have a fraction of relatively larger power-consumption systems (such as, an air-conditioning unit, a stove, a washer, a dryer, etc.) for a given timeframe and use case. However, the relatively large number of chargeable devices currently in use (and even more expected), along with an increasing tendency to use mobile devices, make a compelling case that the cumulative effect is in fact relatively significant.

Building automation is the automatic centralized control of a building's electrical grid, heating, ventilation, and air conditioning, lighting and other systems through a building management system or building automation system (BAS). The objectives of building automation are improved occupant comfort, efficient operation of building systems, and reduction in energy consumption and operating costs.

Home automation is the residential extension of building automation. It is automation of the home, housework, or household activity. Home automation may include centralized control of lighting, HVAC (heating, ventilation, and air conditioning), appliances, security locks of gates and doors and other systems, to provide improved convenience, comfort, energy efficiency, and security.

Known building automation systems (such as, smart-home automation systems) are configured to allow controlling the use of individual devices (appliances) and thereby their electrical power consumption. However, the focus of building automation or home automation is user control, and the focus is not primarily for contributing to leveling or lowering the stress imposed onto the electrical grid, or lowering the peaks (the peak demand) in electricity usage. Moreover, addressing (controlling) individual devices, costly micro-computer-based technology may be implemented, requiring a significant investment by the user. In addition, some known building automation systems require initial set-up and management of elaborate use profiles (resulting in less user convenience).

To solve the problem with existing systems for powering any one of a chargeable electrical device and an electrical device, there is provided an apparatus. The apparatus is configured to lower the cost associated with charging the chargeable electrical device (a device that has a chargeable battery) and/or operating an electrical device (a device that does not have a chargeable battery). In accordance with an embodiment, the apparatus is configured to selectively shift at least some or at least a large part of the power consumption of any one of the chargeable electrical device and the electrical device away from peak hours (during the time of peak demand). In accordance with an embodiment, the apparatus is configured to automatically regulate power consumption (the amount of electrical energy) of the chargeable electrical device (while the chargeable electrical device is being charged either at any time of the day or at times of peak demand) and/or the operation of the electrical device.

For instance, the apparatus is configured to receive and manage any one of the electrical energy pricing and electricity availability (data or information) associated with the electrical grid, and to use any one of the electricity pricing and the electrical energy availability information for determining whether to any one of (A) charge or electrically disconnect the chargeable electrical device and (B) operate or not operate (electrically disconnect) the electrical device (for instance, at a particular time of the day when electricity pricing is relatively lower). Any one of the electricity pricing and electrical energy availability information may be provided by (established by) electricity distributors. The electricity pricing information may be based the electrical energy availability and/or the cost of electricity associated with the spot market.

It will be appreciated that “and/or” means “any one of.”

Plug Load Control (PLC)

In accordance with an embodiment, the apparatus is configured to address the needs associated with plug load control (PLC). In accordance with an embodiment, the apparatus is configured to meet the requirements of an automatic receptacle control device as established by the American Society of Heating, Refrigerating, and Air-Conditioning Engineers (ASHRAE).

For the PLC case (for electrical devices) and for the load-shifting case (for chargeable electrical devices), the problem is that there are (there may be) undesirable and/or unnecessary loads applied to the electrical grid. For the PLC case, there is a savings (reduction in usage) in electrical energy, and there is a prevention of usage of electrical energy during certain times of the day (thereby reducing cost of operating the electrical device). For the load-shifting case, the usage of the chargeable electrical device is shifted from on-peak to off-peak to aid in leveling a usage curve, and in this case no electrical energy is actually saved directly (only indirectly in preventing further infrastructure expansions).

Plug load control calls for reducing electrical power consumption, especially in office spaces, by shutting off at least 50% of standard sockets for a limited time on a scheduled basis. In practical terms, the aim is to reduce standby power consumption of higher-wattage devices in offices (such as printers, coffee machines, etc.) during known times of disuse (e.g. 10 p.m. to 6 a.m.).

An embodiment of the apparatus is configured to implement plug load control (PLC) for new office-space construction and/or developments (or home construction), as well as for retrofitting of existing office spaces and/or home spaces.

In accordance with an embodiment, the apparatus is configured to reduce energy consumption of the chargeable electrical device (and/or the electrical device) by applying plug load control usage to home environments. Most electricity-usage patterns in homes are characterized by recurring periods of relatively lower power usage, e.g. late nighttime (1 a.m. to 5 a.m.), or daytime (9 a.m. to 4 p.m.). During these downtimes, many wall sockets (electrical outlets) may be turned OFF completely to reduce unwanted standby power draw by the chargeable electrical device and/or the electrical device.

To mitigate, at least in part, at least one problem associated with existing systems for powering a chargeable electrical device and/or an electrical device, there is provided (in accordance with a major aspect) an apparatus. The apparatus is for a chargeable electrical device and/or an electrical device each configured to be plugged into and to receive power from an electrical grid. The electrical grid is configured to provide electrical energy in accordance with any one of electrical energy pricing and electrical energy availability. The apparatus includes (and is not limited to) a combination of a first control unit and a second control unit. The first control unit is configured to: (A) receive and to store any one of the electrical energy pricing and electrical energy availability associated with the electrical energy provided by the electrical grid; and (B) transmit the signal related to (having at least in part) any one of the electrical energy pricing, the electrical energy availability and the time-of-day. The second control unit is configured to: (A) be electrically connected to the electrical grid; (B) be electrically connected to the chargeable electrical device and/or the electrical device; (C) receive the signal that was transmitted by the first control unit; (D) electrically connect the chargeable electrical device and/or the electrical device with the electrical grid in such a way as to permit the electrical grid to charge the chargeable electrical device and/or operate the electrical device for the case where the received signal corresponds to a control command signal configured to urge the second control unit 104 to power ON the chargeable electrical device and/or the electrical device; and (E) electrically disconnect the chargeable electrical device and/or the electrical device from the electrical grid in such a way that the chargeable electrical device and/or the electrical device no longer receives electrical energy from the electrical grid for the case where the received signal corresponds to a control command configured to urge the second control unit to power OFF the chargeable electrical device and/or the electrical device.

It will be appreciated that any reference referring to the chargeable electrical device applies to the electrical device. For the load-shifting use case, the apparatus is provided for the chargeable electrical device and/or the electrical device (more so for the chargeable electrical device). It will also be appreciated that the apparatus may be used with an electrical device without involving the chargeable electrical device (that is, the electrical device has no battery or chargeable battery). For this case, the apparatus is used in the PLC use case where not only the chargeable electrical device may be deployed or used with the apparatus, but in addition the apparatus may be used with other types of electrical devices (that don't have or include a chargeable battery), such as computer printers, coffee machines, water coolers, etc., that may be switched off (when required to do just so). Therefore, the description directed to the apparatus with the chargeable electrical device may be equally applicable to an electrical device that is not chargeable per se.

To mitigate, at least in part, at least one problem associated with existing systems for powering any one of a chargeable electrical device and an electrical device, there is provided (in accordance with a major aspect) a method. The method is for operating any one of a chargeable electrical device and an electrical device each configured to be plugged into and to receive power from an electrical grid. The electrical grid is configured to provide electrical energy in accordance with any one of electrical energy pricing and electrical energy availability. The method includes (and is not limited to): (A) receiving and storing any one of the electrical energy pricing and the electrical energy availability associated with the electrical energy provided by the electrical grid; (B) transmitting a signal related to any one of the electrical energy pricing, the electrical energy availability and the time-of-day; (C) receiving the signal from the first control unit; (D) connecting the chargeable electrical device and/or the electrical device with electrical grid in such a way as to permit the electrical grid to charge the chargeable electrical device and/or operate the electrical device for the case where the received signal corresponds to a control command indicating any one of the electrical energy pricing (cost) and electrical energy availability (availability of electricity), and then to power ON the chargeable electrical device (for the case where the cost of electricity is relatively lower, and/or electricity is more available); and (E) electrically disconnecting the chargeable electrical device and/or the electrical device from electrical grid in such a way that the chargeable electrical device and/or the electrical device no longer receives electrical energy from the electrical grid, for the case where the received signal indicates that the cost of electricity is relatively too high (and/or electricity is less available); that is, specifically, the control logic then indicates to power OFF or electrically disconnect, the chargeable electrical device and/or the electrical device from the electrical grid.

To mitigate, at least in part, at least one problem associated with existing systems for powering a chargeable electrical device and/or the electrical device, there is provided (in accordance with a major aspect) an apparatus. The apparatus is for a chargeable electrical device and/or the electrical device configured to be plugged into and to receive power from an electrical grid. The electrical grid is configured to provide electrical energy in accordance with any one of electrical energy pricing and electrical energy availability. The apparatus includes (and is not limited to) a first control unit configured to: (A) receive and to store any one of the electrical energy pricing and the electrical energy availability associated with the electrical energy provided by the electrical grid; and (B) transmit a signal related to any one of the electrical energy pricing, the electrical energy availability and the time-of-day. The first control unit is for a second control unit. The second control unit is configured to: (A) be electrically connected to the electrical grid; (B) be electrically connected to the chargeable electrical device and/or the electrical device; (C) receive the signal from the first control unit; (D) connect the chargeable electrical device and/or the electrical device with electrical grid in such a way as to permit the electrical grid to charge the chargeable electrical device (and/or operate the electrical device) for the case where the received signal provides information indicating that the cost of electricity is relatively lower (and/or electricity is more available) and the control logic indicates to power ON the chargeable electrical device and/or the electrical device; and (E) disconnect the chargeable electrical device and/or the electrical device from electrical grid in such a way that the chargeable electrical device and/or the electrical device no longer receives electrical energy from the electrical grid, for the case where the received signal provides an indication that the price of electricity is relatively higher (and/or electricity is less available) and the control logic indicates (as a result) to power OFF the chargeable electrical device.

To mitigate, at least in part, at least one problem associated with existing systems for powering a chargeable electrical device and/or the electrical device, there is provided (in accordance with a major aspect) an apparatus. The apparatus is for a chargeable electrical device and/or the electrical device each configured to be plugged into and to receive power from an electrical grid. The electrical grid is configured to provide electrical energy in accordance with any one of electrical energy pricing and electrical energy availability. The apparatus includes (and is not limited to) a second control unit configured to: (A) be electrically connected to the electrical grid; (B) be electrically connected to the chargeable electrical device and/or the electrical device; (C) receive the signal from the first control unit; (D) connect the chargeable electrical device and/or the electrical device with electrical grid in such a way as to permit the electrical grid to charge the chargeable electrical device and/or operate the electrical device for the case where the received signal indicates the cost of electricity is relatively lower (and/or electricity is more available) and the control logic as a result then indicates to power ON the chargeable electrical device and/or the electrical device; and (E) disconnect the chargeable electrical device and/or the electrical device from the electrical grid in such a way that the chargeable electrical device and/or the electrical device no longer receives electrical energy from the electrical grid, for the case where the received signal indicates that the electrical energy cost is relatively higher (and/or electricity is less available) and the control logic then as a result indicates to power OFF the chargeable electrical device and/or the electrical device. The second control unit is for a first control unit. The first control unit is configured to: (A) receive and to store any one of the electrical energy pricing and the electrical energy availability associated with the electrical energy provided by the electrical grid; and (B) transmit a signal related to any one of the electrical energy pricing, the electrical energy availability and the time-of-day.

To mitigate, at least in part, at least one problem associated with existing systems for powering a chargeable electrical device and/or the electrical device, there is provided (in accordance with a major aspect) an apparatus. The apparatus is for a chargeable electrical device and/or an electrical device configured to be plugged into and to receive power from an electrical grid, and the electrical grid configured to provide electrical energy in accordance with any one of electrical energy pricing and electrical energy availability. The apparatus includes a first control unit configured to control operation of a second control unit. The first control unit is configured to control operation of a second control unit by, for instance, using uni-directional signalling (if so desired).

To mitigate, at least in part, at least one problem associated with existing systems for powering a chargeable electrical device and/or the electrical device, there is provided (in accordance with a major aspect) an apparatus. The apparatus is for a chargeable electrical device and/or the electrical device configured to be plugged into and to receive power from an electrical grid, and the electrical grid configured to provide electrical energy in accordance with any one of electrical energy pricing and electrical energy availability. The apparatus includes a second control unit configured to receive signals corresponding to control operations from first control unit.

To mitigate, at least in part, at least one problem associated with existing systems for powering a chargeable electrical device and/or the electrical device, there is provided (in accordance with a major aspect) a method of operating an apparatus for a chargeable electrical device and/or the electrical device each configured to be plugged into and to receive power from an electrical grid, and the electrical grid configured to provide electrical energy in accordance with any one of electrical energy pricing and electrical energy availability, the apparatus including a first control unit configured to control operation of a second control unit.

To mitigate, at least in part, at least one problem associated with existing systems for powering a chargeable electrical device and/or the electrical device, there is provided (in accordance with a major aspect) a method of operating an apparatus for a chargeable electrical device and/or the electrical device each configured to be plugged into and to receive power from an electrical grid, and the electrical grid configured to provide electrical energy in accordance with any one of electrical energy pricing and electrical energy availability, the apparatus including a second control unit configured to receive signals corresponding to control operations from first control unit.

It will be appreciated that the signal received by the first control unit may include the availability of the electricity and/or the pricing of electricity. It will be appreciated that electricity pricing is one way of indicating electricity availability (supply). Another option may include the usage of other metrics (attributes of) to indicate the availability (supply) of electricity.

In accordance with an embodiment, there is provided an apparatus for any one of a chargeable electrical device and an electrical device each being configured to be plugged into and to receive power from an electrical grid, and the electrical grid being configured to provide electrical energy in accordance with any one of electrical energy pricing and electrical energy availability, the apparatus comprising a first control unit configured to control operation of a second control unit.

In accordance with an embodiment, there is provided an apparatus for any one of a chargeable electrical device and an electrical device each being configured to be plugged into and to receive power from an electrical grid, the electrical grid being configured to provide electrical energy in accordance with any one of electrical energy pricing and availability, the apparatus comprising a second control unit configured to receive control operation from first control unit.

In accordance with an embodiment, there is provided a method of operating an apparatus for any one of a chargeable electrical device and an electrical device each being configured to be plugged into and to receive power from an electrical grid, and the electrical grid being configured to provide electrical energy in accordance with any one of electrical energy pricing and electrical energy availability, the apparatus including a first control unit configured to control operation of a second control unit.

In accordance with an embodiment, there is provided a method of operating an apparatus for any one of a chargeable electrical device and an electrical device each being configured to be plugged into and to receive power from an electrical grid, and the electrical grid being configured to provide electrical energy in accordance with any one of electrical energy pricing and electrical energy availability, the apparatus including a second control unit configured to receive control operation from the first control unit.

In accordance with an embodiment, there is provided an apparatus for use with any one of a chargeable electrical device and an electrical device each being configured to be plugged into, and to receive power, from an electrical grid, and the electrical grid configured to provide electrical energy in accordance with any one of electrical energy pricing and electrical energy availability, and the apparatus including: a first control unit 102 configured to: (A) receive and store any one of the electrical energy pricing and the electrical energy availability associated with the electrical energy provided by the electrical grid; and (B) transmit a signal having, at least in part, any one of the electrical energy pricing, the electrical energy availability and the time-of-day. The apparatus also includes a second control unit 104 configured to: (A) be electrically connected to the electrical grid; and be electrically connected to any one of the chargeable electrical device and the electrical device; and (B) receive the signal being transmitted by the first control unit 102; and electrically connect any one of the chargeable electrical device and the electrical device with the electrical grid in such a way as to permit the electrical grid to any one of (i) charge the chargeable electrical device, and (ii) operate the electrical device for a case where the signal that was received from the first control unit 102 indicates that any one of a cost of electricity is relatively lower and electricity is more available so that the second control unit 104 is urged to power ON any one of the chargeable electrical device and the electrical device, and (iii) electrically disconnect any one of the chargeable electrical device and the electrical device from the electrical grid in such a way that any one of the chargeable electrical device and the electrical device no longer receives the electrical energy from the electrical grid for the case where the signal that was received from the first control unit 102 indicates that any one of the cost of electricity is relatively higher and electricity is less available so that the second control unit 104 is urged to power OFF any one of the chargeable electrical device and the electrical device.

In view of the above, the apparatus provides a lower cost for operating the electrical grid.

Other aspects are identified in the claims.

Other aspects and features of the non-limiting embodiments may now become apparent to those skilled in the art upon review of the following detailed description of the non-limiting embodiments with the accompanying drawings.

### BRIEF DESCRIPTION OF THE DRAWINGS

The non-limiting embodiments may be more fully appreciated by reference to the following detailed description of the non-limiting embodiments when taken in conjunction with the accompanying drawings, in which:

FIG. 1 depicts a schematic representation of an embodiment of the apparatus including a first control unit and a second control unit.

FIG. 2 depicts a schematic representation of an embodiment of a table, depicting embodiments of a switching logic of the second control unit of FIG. 1;

FIG. 3 depicts a schematic representation of an embodiment of a timing diagram for the second control unit;

FIG. 4 depicts a schematic representation of an embodiment of a table, depicting embodiments of a switching logic of the second control unit;

FIG. 5 depicts a schematic representation of an embodiment of a table, depicting architectures for the first control unit and the second control unit;

FIG. 6 depicts a schematic representation of an embodiment of the first control unit and the second control unit deployed (incorporated) in a plug-wall socket system;

FIG. 7 depicts a schematic representation of an embodiment of the first control unit and the second control unit of FIG. 1;

FIG. 8 depicts a schematic representation of an embodiment of the first control unit and the second control unit of FIG. 1;

FIG. 9 depicts a schematic representation of an embodiment of a plug-load control installation of the apparatus of FIG. 1;

FIG. 10 depicts a schematic and isometric representation of an office space containing various embodiments of the second control unit 104 of FIG. 1, each different embodiment whereof corresponding to a plug-load control installation of FIG. 9; and

FIG. 11 depicts a schematic representation of an embodiment of the second control unit of FIG. 10.

The drawings are not necessarily to scale and may be illustrated by phantom lines, diagrammatic representations and fragmentary views. In certain instances, details unnecessary for an understanding of the embodiments (and/or details that render other details difficult to perceive) may have been omitted.

Corresponding reference characters indicate corresponding components throughout the several figures of the Drawings. Elements in the several figures are illustrated for simplicity and clarity and have not been drawn to scale. The dimensions of some of the elements in the figures may be emphasized relative to other elements for facilitating an understanding of the various disclosed embodiments. In addition, common, but well-understood, elements that are useful or necessary in commercially feasible embodiments are often not depicted to provide a less obstructed view of the embodiments of the present disclosure.

### LISTING OF REFERENCE NUMERALS USED IN THE DRAWINGS

100 apparatus
102 first control unit
104 second control unit
200 table
202 table
204 table
900 chargeable electrical device
901 electrical device
902 electrical grid
1001 second control unit
1002 second control unit
1003 second control unit
1004 second control unit
1005 second control unit
1006 second control unit
1007 wall monitor
1008 water cooler
1009 kitchen equipment
1010 laptop
1011 humidifier
1012 lamp
1013 office
1101 plug
1102 feature
1103 socket

### DETAILED DESCRIPTION OF THE NON-LIMITING EMBODIMENTS(S)

The following detailed description is merely exemplary and is not intended to limit the described embodiments or the application and uses of the described embodiments. As used, the word “exemplary” or “illustrative” means “serving as an example, instance, or illustration.” Any implementation described as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure. The scope of the invention is defined by the claims. For the description, the terms “upper,” “lower,” “left,” “rear,” “right,” “front,” “vertical,” “horizontal,” and derivatives thereof shall relate to the examples as oriented in the drawings. There is no intention to be bound by any expressed or implied theory in the preceding Technical Field, Background, Summary or the following detailed description. It is also to be understood that the devices and processes illustrated in the attached drawings, and described in the following specification, are exemplary embodiments (examples), aspects and/or concepts defined in the appended claims. Hence, dimensions and other physical characteristics relating to the embodiments disclosed are not to be considered as limiting, unless the claims expressly state otherwise. It is understood that the phrase “at least one” is equivalent to “a”. The aspects (examples, alterations, modifications, options, variations, embodiments and any equivalent thereof) are described regarding the drawings. It should be understood that the invention is limited to the subject matter provided by the claims, and that the invention is not limited to the particular aspects depicted and described.

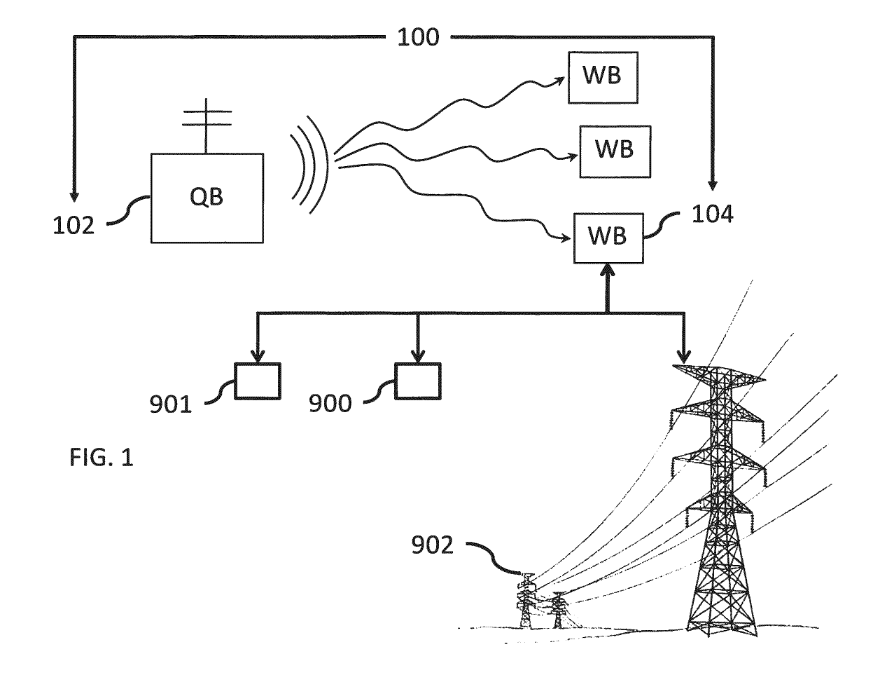

FIG. 1 depicts a schematic representation of an embodiment of the apparatus 100 including a first control unit 102 and a second control unit 104.

The apparatus 100 is for a chargeable electrical device 900 and/or an electrical device 901. The chargeable electrical device 900 is a device that includes a chargeable battery. The electrical device 901 is a device that does not include a chargeable battery. The chargeable electrical device 900 and/or the electrical device 901 are configured to be plugged into and to receive power from an electrical grid 902. The electrical grid 902 is configured to provide electrical energy in accordance with electrical energy pricing (and/or availability). The apparatus 100 includes (and is not limited to) a combination of the first control unit 102 and the second control unit 104.

The first control unit 102 and the second control unit 104 each includes: (A) a processor assembly, (B) a memory assembly operatively connected to the processor assembly, and the memory assembly tangibly stores control logic (executable programmed instructions) configured to urge the processor to execute predetermined operations), (C) an input module, and (D) an output module.

The control logic of the first control unit 102 is configured to: (A) read (receive) a signal representing the cost of electricity (the signal may be received from the distributor of the electrical energy or from the operator of the electrical grid), (B) store the signal representing the cost of electricity to the memory assembly of the first control unit 102, and (C) transmit (provide) a signal representing the cost of electricity to the second control unit 104.

The control logic of the second control unit 104 is configured to: (A) read (receive) the signal representing the cost of electricity that is provided (transmitted) from the first control unit 102; (B) store the signal representing the cost of electricity to the memory assembly of the second control unit 104; (C) execute an analysis control logic configured to analyze the signal representing the cost of electricity; (D) provide (compute) a control ON/OFF signal (power ON or power OFF signal), in response to the signal representing the cost of electricity; and (E) control operation of any one of the chargeable electrical device 900 and the electrical device 901 based on the control ON/OFF signal that was computed (that is, either power ON or power OFF any one of the chargeable electrical device 900 and the electrical device 901).

In accordance with the embodiment depicted in FIG. 1, the apparatus 100 includes a combination of the first control unit 102 (or at least one or more instances of the first control unit 102), and the second control unit 104 (at least one or more instances of the second control unit 104). The first control unit 102 may be called a queen-bee unit (QB unit). The second control unit 104 may be called a worker-bee unit (WB unit).

In accordance with an embodiment, there is provided the apparatus 100. The apparatus 100 is for the chargeable electrical device 900 and/or the electrical device 901. The electrical device 901 is a device that does not include a chargeable battery. The chargeable electrical device 900 the electrical device 901 are configured to be plugged into and to receive power from an electrical grid 902. The electrical grid 902 is configured to provide electrical energy in accordance with any one of the electrical energy pricing and the electrical energy availability. The apparatus 100 includes (and is not limited to) a combination of the first control unit 102 and the second control unit 104.

In accordance with an embodiment, the first control unit 102 is configured to receive and to store any one of the electrical energy pricing and the electrical energy availability associated with the electrical energy provided by the electrical grid 902. The first control unit 102 is also configured to transmit a signal related to any one of the electrical energy pricing, the electrical energy availability and the time-of-day.

The second control unit 104 is configured to include a control command and switching logic, and the second control unit 104 is configured to receive (from the first control unit 102) a signal (a control command signal) corresponding to (providing) the electrical energy pricing (and/or availability) associated with the electrical energy. In response, the second control unit 104 is configured to (depending on the control command signal coming from, or transmitted by, the first control unit 102), either switch ON and/or switch OFF (turn the power ON or the power OFF to the electrical device 901 and/or the chargeable electrical device 900, whichever is operatively connected to the second control unit 104). The control command signal indicates (is configured to indicate) whether to power ON and power OFF the chargeable electrical device 900 based on any one of the electrical energy pricing and the electrical energy availability. Specifically, the control command signal that is issued by the first control unit 102 (that is, transmitted from the QB unit to the WB unit) does not necessarily literally define ON/OFF power control. The control command signal that is issued from (transmitted by) the first control unit 102 (to the second control unit 104) indicates “very available energy” (that is, energy that costs relatively less) or “very scarce energy” (that is, energy that costs relatively more). The second control unit 104 (that is, the WB unit) receives the control command signal from the QB unit, and then the WB unit translates or converts the control command signal (provided by the QB unit) into an ON/OFF control (which may be further based on the profile associated with the WB unit).

The second control unit 104 is configured to be electrically connected to the electrical grid 902. The second control unit 104 is also configured to be electrically connected to the chargeable electrical device 900 and/or the electrical device 901. The second control unit 104 is also configured to receive the signal from the first control unit 102. The second control unit 104 is also configured to connect the chargeable electrical device 900 and/or the electrical device 901 with electrical grid 902. This is done in such a way as to permit the electrical grid 902 to charge the chargeable electrical device 900 and/or operate the electrical device 901, for the case where the signal provides an indication that the cost of electricity is relatively lower (and/or electricity is more available) and the control logic as a result of any one of the electrical-energy price and the electrical availability indication then provides a control command indicating to power ON the chargeable electrical device 900 and/or operate the electrical device 901. The second control unit 104 is also configured to disconnect the chargeable electrical device 900 and/or the electrical device 901 from electrical grid 902. This is done in such a way that the chargeable electrical device 900 and/or the electrical device 901 no longer receives electrical energy from the electrical grid 902, for the case where the signal from the first control unit 102 indicates that the cost of electricity is relatively higher (and/or electricity is less available) and the control logic of the second control unit 104 then (as a result of the higher cost (or reduced availability) of electricity) provides a control command indicating to power OFF the chargeable electrical device 900 and/or the electrical device 901.

It will be appreciated that the description refers to the chargeable electrical device 900, and the description for the chargeable electrical device 900 applies equally to the electrical device 901. For the load-shifting use case, this is acceptable simply because the apparatus 100 is provided specifically for the chargeable electrical device. However, it will also be appreciated that the apparatus 100 may be used with an electrical device that does not include the chargeable electrical device (that is, the electrical device has no battery or chargeable battery. For this case, the apparatus 100 is used in the PLC use case where not only the chargeable electrical device may be deployed or used with the apparatus 100, but in addition the apparatus 100 may be used with other types of electrical devices, such as computer printers, coffee machines, water coolers, etc., that may be switched off (when required to do just so). Therefore, the description directed to the apparatus 100 with the chargeable electrical device may be equally applicable to an electrical device that is not chargeable per se.

The first control unit 102 is configured to transmit a signal related to any one of the electrical energy pricing, the electrical energy availability and the time-of-day to the second control unit 104. The second control unit 104 is configured to receive the signal from the first control unit 102. The first control unit 102 is configured to identify the current time of day and to receive and store pricing of electrical energy (such as, the information on the availability of and/or the pricing of electrical energy) associated with the electrical grid 902.

In accordance with an embodiment, the information may be any one (or more) of a number of discrete electricity price levels of electricity (e.g. high/on-peak, mid and low/off-peak) for any given calendar date and time of day. In accordance with an embodiment, the information may be a real-time price of electricity based on the current balance of demand and supply.

In accordance with an embodiment, the first control unit 102 is for usage in plug load control. The first control unit 102 is configured to work on a time-of-day basis, as pricing is (or may be) irrelevant. For the plug load control usage case, the first control unit 102 is configured to be linked to at least one or more additional information sources, both internal or external to the first control unit 102, such as any one of a timer (internal), clock (internal or external), a home occupancy sensor (internal and/or external), a smoke detector, a smoke alarm (internal or external), etc., that allow an informed decision on when to apply plug load control. An external information source may be relayed to the first control unit 102 using appropriate electronics and programming, possibly leveraging APIs (Application Program Interfaces) such as ZOIPER or IFTTT.

In accordance with an embodiment, the information may be stored (statically) in the first control unit 102, and may rely on pre-determined cyclical variations of any one of the electrical energy pricing and the electrical energy availability. In another embodiment, the first control unit 102 is configured to gather information (on a PULL basis), and to update the information (such as, dynamically) from an information source, such as the electricity distributor or an intermediary service, by using an available communication medium such as electromagnetic or sound waves, phone or cable television (TV) lines, the internet (a network) or via the power line. Alternatively, the information may be fed (on a PUSH basis), and updated (such as, dynamically) from an above-mentioned source by using an above-mentioned communication methods and systems.

In accordance with an embodiment, the first control unit 102 is configured to (A) receive any one of the electrical energy pricing and the electrical energy availability; (B) to store the electricity pricing information; and/or (C) broadcast a signal that corresponds to any one of the electrical energy pricing and the electrical energy availability (such as, any one of the current electricity availability, the electricity pricing, the time-of-day, occupancy sensors, etc.). It will be appreciated that the signal (related to any one of the electrical energy pricing, the electrical energy availability and the time-of-day) may be broadcast (transmitted) by the first control unit 102 by using an appropriate communication medium as a signal carrier, such as the electromagnetic or sound waves, phone lines or cable TV lines, the internet (networks) or via the power line (an electrical grid 902 in the building), etc.

In terms of timing, the signal of the first control unit 102 may be continuous, periodically recurring or a one-time signal sent out when the availability and pricing levels change. The type of the signal (related to any one of the electrical energy pricing, the electrical energy availability and the time-of-day) transmitted by the first control unit 102 may be dependent on the chosen communication medium. For instance, in the case of the power line, the signal may be a controlled small-signal interference modulated onto the carrier signal. Alternatively, the signal may be a change in the carrier signal voltage amplitude or frequency, etc.

The second control unit 104 is configured to be operatively connected (coupled) to the first control unit 102 via a chosen communication medium (e.g. a power line). The second control unit 104 is configured to receive and interpret the signal provided by the first control unit 102. The second control unit 104 is configured to control a controllable switch (or may include the controllable switch). The controllable switch is configured to route through (or interrupts) an electrical power connection to the chargeable electrical device 900 and/or the electrical device 901 (and/or to an electrical appliance) that is operatively attached to the controllable switch. The second control unit 104 is configured to use (or refer to) a plurality of switching profiles to determine whether to switch the power ON or the power OFF (via the controllable switch) that is to be connected or disconnected the chargeable electrical device 900 and/or the electrical device 901 based on the signal (related to any one of the electrical energy pricing, the electrical energy availability and the time-of-day) provided by the first control unit 102 along with control logic of the second control unit 104 reading the signal from the first control unit 102 and then as a result providing a control signal configured to control connection and disconnection of electrical power to the electrical device 901 and/or the chargeable electrical device 900.

Switching Logic

A switching profile may be characterized by a set of switching rules that specify cases when the controllable switch of second control unit 104 is powered ON or is powered OFF. For example, the switching rules include: (A) the “always ON” switching rule, and/or (B) the “always OFF” switching rule. A more complex embodiment includes a “power saver” switching rule, which switches between power ON and power OFF based on a given duty cycle (e.g. 25%: 30 minutes ON and 1.5 hours OFF). A more complex embodiment includes a switching rule that switches power ON for six (6) hours and switches power OFF for six (6) days and 18 hours (called the “Weekly Power Saver” switching rule). A switching profile and its respective switching rule set may make use of additional sensory input, such as a power consumption sensor, allowing a “power ON until charged” switching state (for the controllable switch), thereby reducing phantom power draw, or an occupancy sensor, allowing a “power OFF unless occupied” switching state (for the controllable switch).

In accordance with an embodiment, the second control unit 104 includes a different switching profile, depending on usage of the second control unit 104. For example, instances of the second control unit 104 for respective chargeable electrical devices may differ depending on the charging frequency associated with a respective chargeable electrical device 900 and/or a respective electrical device 901. The second control unit 104 may be configured to provide (or store) multiple profiles, as well as a way of manually changing between the multiple profiles (e.g. by using a rotary dial).

In accordance with an embodiment, the second control unit 104 includes a manual override button (an override switch) configured to allows the user to close the controllable switch, and continuously provide power to the chargeable electrical device 900 and/or the electrical device 901. The manual override button may be configured to be manually released (to engage), or may include a spring-loaded override button that is released upon a predetermined event (e.g. when the chargeable electrical device 900 and/or the electrical device 901 are unplugged).

The number of distinct signals of the first control unit 102 may be dependent on the complexity of the switching logic. For example, in an electrical grid 902 associated with two distinct pricing (and/or availability) levels, the first control unit 102 is configured to broadcast two distinct signals: a first signal having on-peak pricing (corresponding to low availability) and a second signal having off-peak pricing (corresponding to high availability).

For the case where there is direct access to an energy market where pricing is dynamically based on actual availability, the first control unit 102 is configured to discretize the price span into different segments (for example, 20 different segments) and send out signals accordingly, requiring distinct signals (such as, 20 distinct signals) for the first control unit 102.

A sophisticated plug load control system may have the first control unit 102 configured to broadcast a distinct signal for each minute of the day (such as, a rough timestamp) having distinct signals (such as, 1440 distinct signals) for the first control unit 102. This arrangement may allow the instances of the second control unit 104, and future devices containing the second control unit 104, to perform certain (predetermined) actions based on the timestamp (for example, the chargeable electrical device 900 and/or the electrical device 901 or a device recovering from plug load control-induced power cut could reset its internal clock).

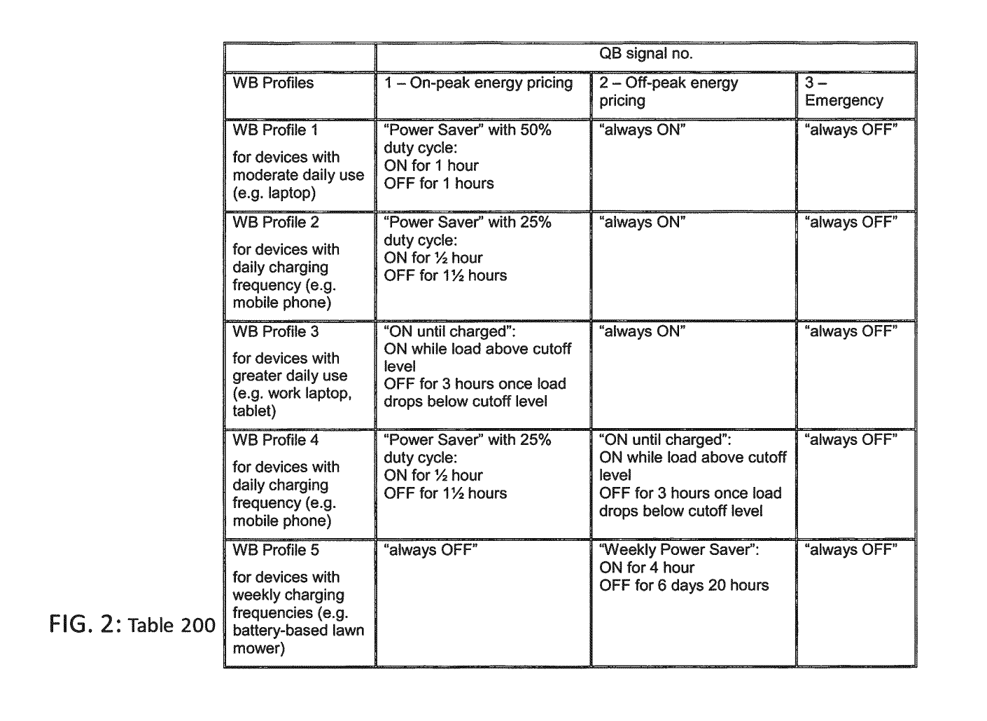

FIG. 2 depicts a schematic representation of an embodiment of a table 200, depicting embodiments of a switching logic of the second control unit 104 of FIG. 1.

In accordance with the embodiment depicted in FIG. 2, the switching logic of the second control unit 104 is used for the chargeable electrical device 900 and/or the electrical device 901.

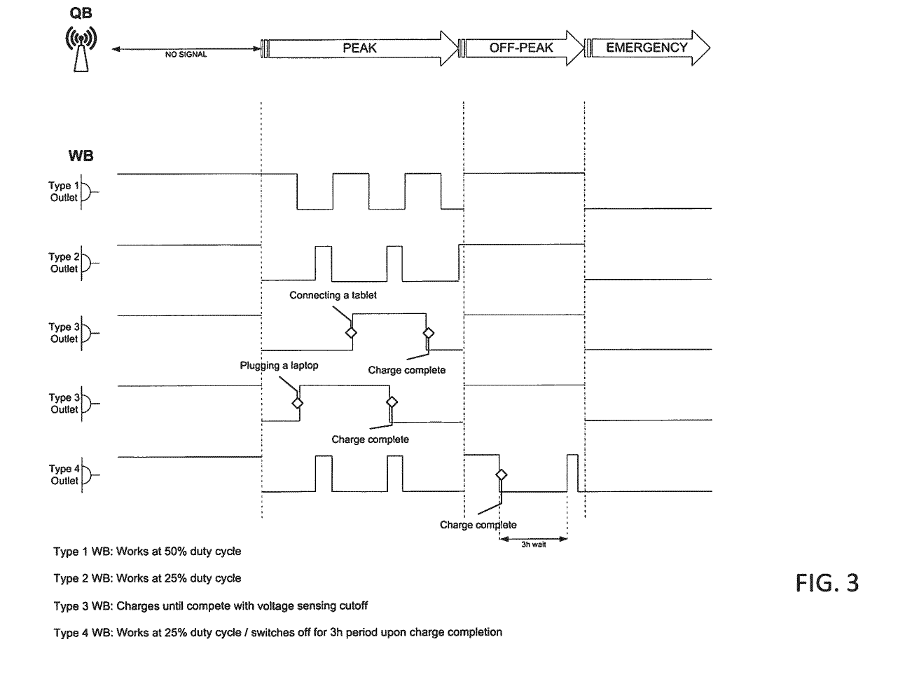

FIG. 3 depicts a schematic representation of an embodiment of a timing diagram for different types of the second control unit 104 equipped with different switching logic.

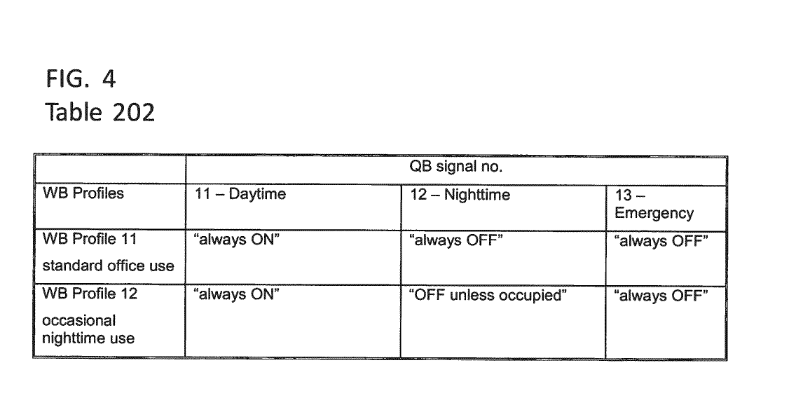

FIG. 4 depicts a schematic representation of an embodiment of a table 202, depicting embodiments of a switching logic of the second control unit 104.

In accordance with an embodiment, the switching logic of the second control unit 104 is for plug load control.

The nomenclature of first control unit 102 and the second control unit 104 may be interpreted as suggestive of a typical master-slave relationship. Alternatively, this may not be the case, as the first control unit 102 may be configured to not communicate a signal to the second control unit 104 in which the signal specifically identifies what to do (for the second control unit 104). Rather, the first control unit 102 broadcasts a certain predetermined signal (e.g., low energy pricing during off-peak times), upon which the second control unit 104 decides what specific actions to take or execute (such as, switch power ON for a wall socket or plug).

Overview of Architectures

Depending on the selected communication technology used, the first control unit 102 and the second control unit 104 may be located at different sites in the power network (electrical grid 902), resulting in considerably different ramifications for a specific architecture.

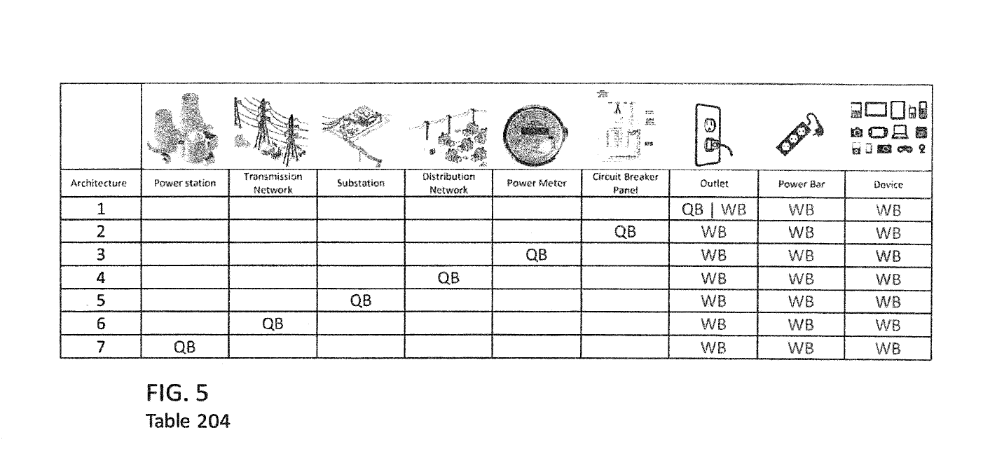

FIG. 5 depicts a schematic representation of an embodiment of a table 204, depicting architectures for the first control unit 102 and the second control unit 104.

FIG. 5 depicts an overview of the embodiments (the architectures). It will be appreciated that the second control unit 104 may be contained or housed within a power outlet (a wall plug), power bars (or equivalent, such as plug-on multi-sockets), or in an electrical device (the chargeable electrical device 900 and/or the electrical device 901). In the former two cases, the second control unit 104 is configured to switch power ON or power OFF in an integrated socket (wall outlet) that the second control unit 104 governs (controls), and, by extension, to the plugged-in device (the chargeable electrical device 900 and/or the electrical device 901). However, for the case where the second control unit 104 is integrated directly within the chargeable electrical device 900 and/or the electrical device 901 (device or appliance), the second control unit 104 is configured to directly control the power consumption of the chargeable electrical device 900 and/or the electrical device 901.

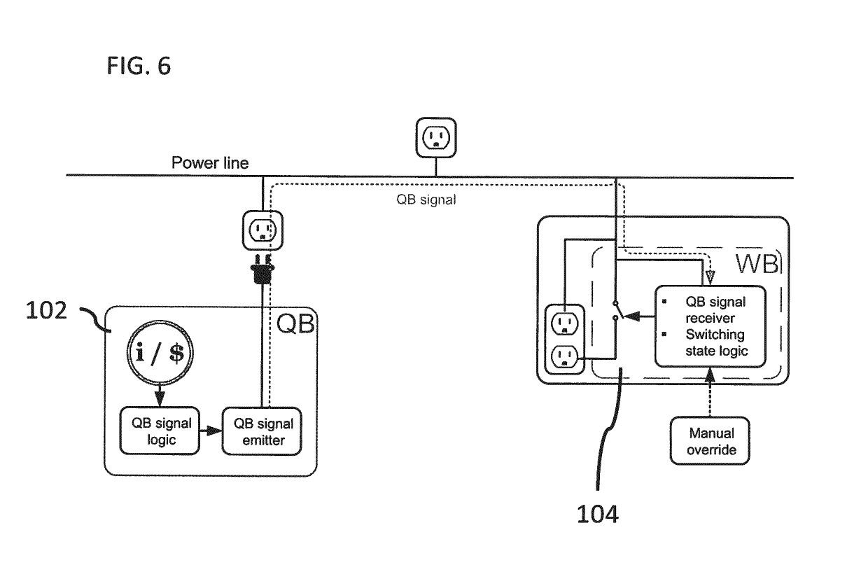

FIG. 6 depicts a schematic representation of an embodiment of the first control unit 102 and the second control unit 104 of FIG. 1.

In accordance with the embodiment depicted in FIG. 6, the first control unit 102 and the second control unit 104 are deployed (incorporated) in a plug-wall socket system. For the embodiment depicted in FIG. 6 (based on architecture number 1 found in table 204 depicted in FIG. 5), the first control unit 102 is plugged into a wall socket of an electrical billing unit (or an apartment electrical billing unit). Information on electricity pricing is statically saved in the memory assembly of the first control unit 102. The internal calendar and clock of the first control unit 102 is configured to allow the first control unit 102 to know which pricing level currently applies. The first control unit 102 is configured to broadcast a corresponding signal by modulation onto a carrier signal to be transmitted via the local power line (to the second control unit 104).

Multiple wall outlets are installed, and are configured to provide a normal socket (an uncontrolled socket) and a green socket (a controllable socket that is configured to be controllable by the second control unit 104). The second control unit 104 is positioned in the wall outlet, and the second control unit 104 is configured to control (govern) the operation of the green socket, such as, switching power ON or power OFF, according to the signal received from the first control unit 102, and the internal settings (programming) of the second control unit 104.

The second control unit 104 may include (provide) a manual override button configured to allow the user to supply power via the green socket for the case where the switching profile of the second control unit 104 would normally cut power (power OFF) to the green socket in accordance with programmed instructions.

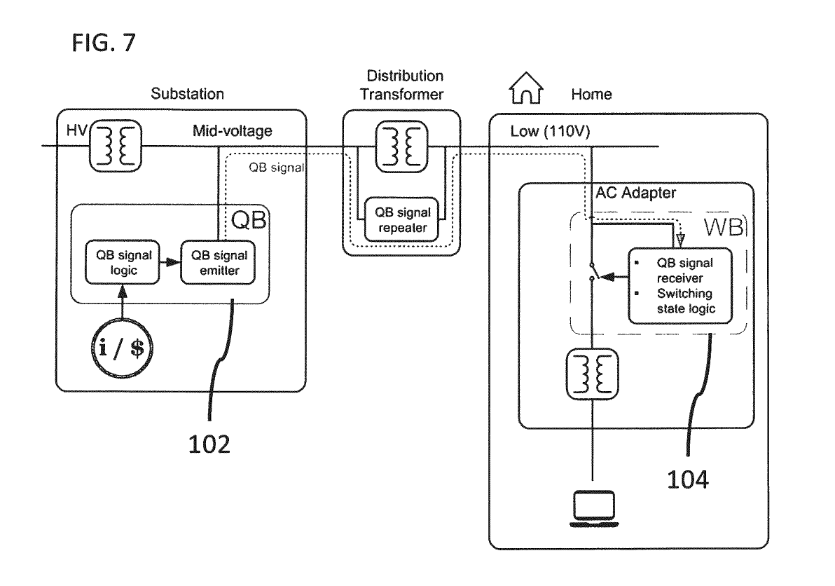

FIG. 7 depicts a schematic representation of an embodiment of the first control unit 102 of FIG. 1.

In accordance with the embodiment depicted in FIG. 7, the first control unit 102 is deployed in a substation level. The embodiment depicted in FIG. 7 is based on the architecture number 5 found in table 204 depicted in FIG. 5. The first control unit 102 is installed at the level of a distribution substation. The distribution substation (also called an electrical substation or a substation) is a part of an electrical generation, transmission, and distribution system. Substations transform voltage from high to low, or the reverse, or perform any of several other important functions. Between the generating station and consumer, electric power may flow through several substations at different voltage levels.

Based on its real-time availability, electricity is dynamically priced. The first control unit 102 is configured to broadcast a signal corresponding to the current pricing level (the dynamically priced electricity). The first control unit 102 is configured to transmit the signal (related to any one of the electrical energy pricing, the electrical energy availability and the time-of-day) as a high-frequency modulation over the distribution power line(s), necessitating a signal repeater, where required, at a downstream transformer station(s).

In each connected billing unit, users are able to use conventional appliances but are encouraged to use second control unit 104 for controlling devices (the chargeable electrical device 900 and/or the electrical device 901). For instance, a portable laptop's AC adapter may include an instance of the second control unit 104 configured to switch power to the laptop OFF and ON (intelligently) based on electricity pricing and the necessary power draw.

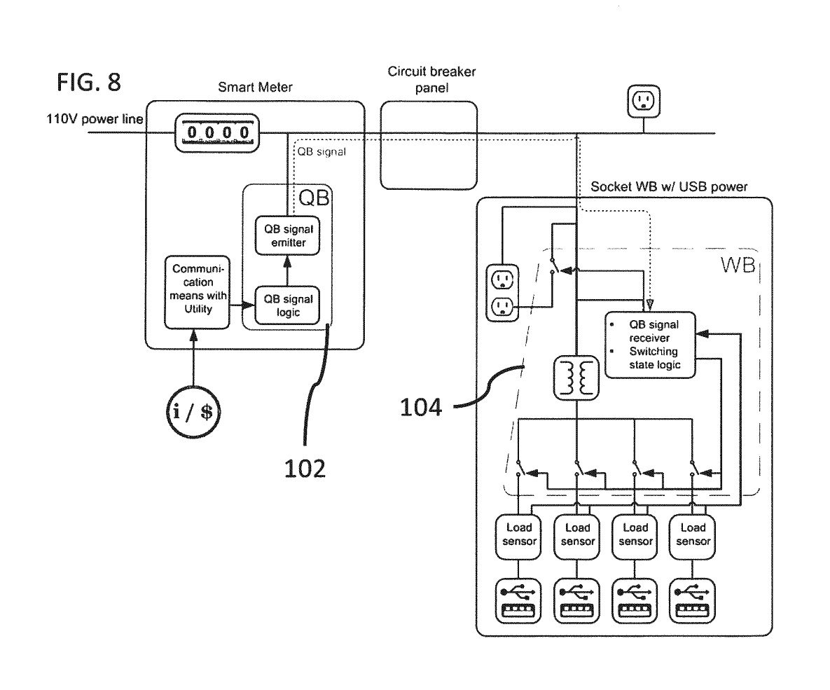

FIG. 8 depicts a schematic representation of an embodiment of the first control unit 102 of FIG. 1;

In accordance with the embodiment depicted in FIG. 8, the first control unit 102 is deployed at a smart meter (a computer-controllable electricity meter). An electricity meter, electric meter, or energy meter is a device that measures the amount of electric energy consumed by a residence, business, or an electrically powered device. The embodiment depicted in FIG. 8 is based on architecture number 3 in found in table 204 as depicted in FIG. 5. The first control unit 102 is installed at the level of the power meter. This embodiment is used for the case where the power meter is a smart meter (the smart meter has an existing communication connection to the electrical utility). This channel is used to provide the first control unit 102 with real-time information on (about or having) any one of the electrical energy pricing and the electrical energy availability, allowing the first control unit 102 to broadcast a signal corresponding to any one of the electrical energy pricing and the electrical energy availability to the second control unit 104. The signal may be transmitted as a high-frequency modulation over the power line within the billing unit.

In the billing unit, the second control unit 104 provides a USB socket configured to provide USB power. For instance, the second control unit 104 includes: (A) a normal socket, (B) a switchable green socket, a converter assembly (from about 110 volts AC to about 5 volts DC), and (C) a switchable outlet configured, for instance, for DC voltage output (such as, 5 VDC). In accordance with an option, the second control unit 104 includes a surge protection circuit.

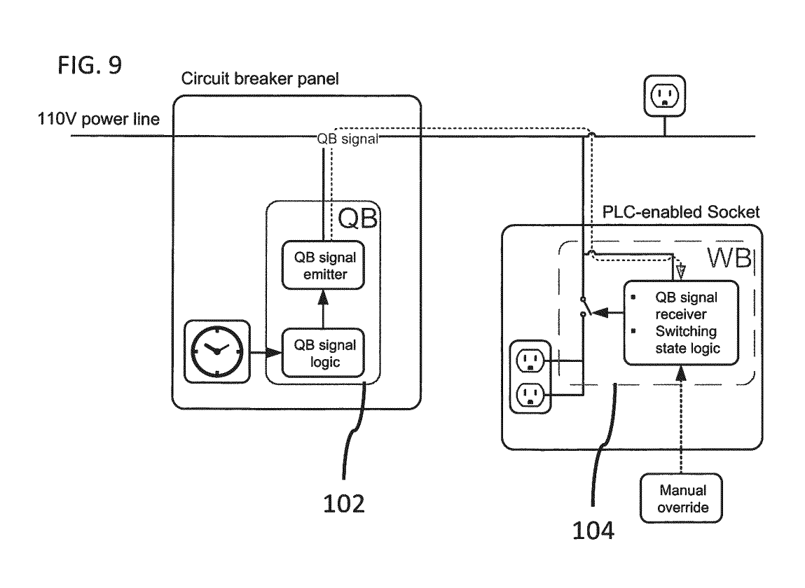

FIG. 9 depicts a schematic representation of an embodiment of a plug-load control installation of the apparatus 100 of FIG. 1.

Referring to FIG. 9, there is depicted a plug load control installation. This embodiment is based on architecture number 2 found in table 204 and depicted in FIG. 5. The first control unit 102 is installed at the level of a circuit breaker panel of an office floor. For PLC (Plug Load Control), the first control unit 102 is configured to operate on a static basis, requiring no live information update from any external source except optionally a central clock.

In accordance with an embodiment, the first control unit 102 is configured to transmit a signal that keeps the second control unit 104 (all instances of the plug load control-enabled sockets) powered ON during the day and powered OFF during nighttime. The duration may be adjusted by the office space owner and/or operator. The signal may be transmitted as a high-frequency modulation over the power line within the office space.

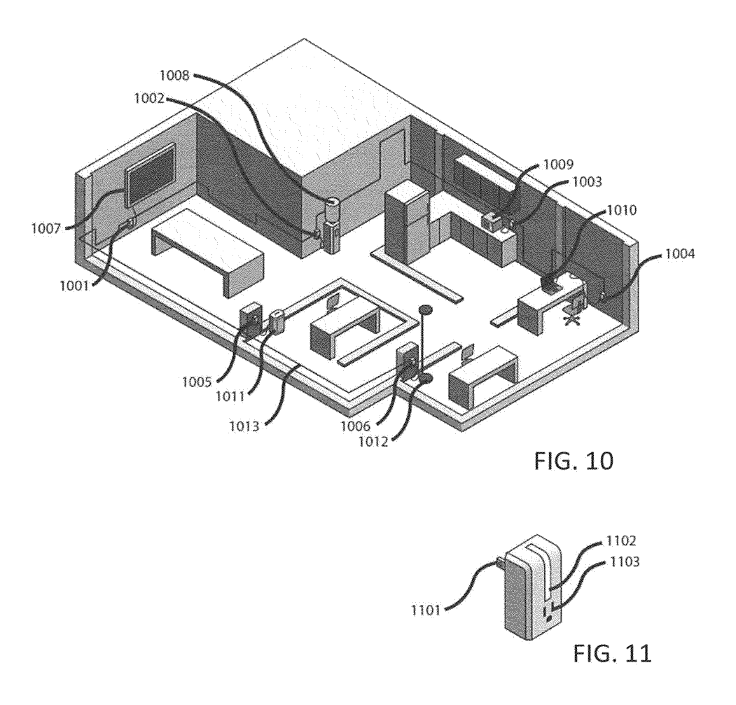

FIG. 10 depicts a schematic isometric representation of an office space containing various embodiments of the second control unit 104 of FIG. 1, each different embodiment whereof corresponding to a plug-load control installation of FIG. 9.

FIG. 11 depicts a schematic representation of an embodiment of the second control unit 104 of FIG. 10.

FIGS. 10 and 11 depict a second control unit 1001 (also called a plug-load controlled socket, and as a first example is for a wall monitor), a second control unit 1002 (example 2, for water cooler), a second control unit 1003 (example 3, for kitchen equipment), a second control unit 1004 (example 4, for laptop), a second control unit 1005 (example 5, for humidifier), a second control unit 1006 (example 6, for lamp), a wall monitor 1007, a water cooler 1008, kitchen equipment 1009, a laptop 1010, a humidifier 1011, a lamp 1012, mains wiring in office 1013, a plug 1101, a feature 1102 (indicating type of second control unit), a socket 1103 for attached device.

For the case of the office space, various sockets are deployed according to FIG. 10, some of which are plug load control-enabled (featuring the second control unit 104) and some of which are standard sockets. The plug-load control can also be achieved by using: (A) instances of the second control unit 104 that are plugged into standard sockets (as depicted in FIG. 11), and/or (B) instances of the second control unit 104 that are plugged into the end of a power extension cable.

In accordance with the embodiment as depicted in FIG. 10, different embodiments of the second control unit 104 are configured to include switching logic specific to a certain type of electric devices. For example, the second control unit 1001 (that is, the plug-load controlled socket) is for a wall monitor 1007, and is configured so that the second control unit 1001 (that is, the plug-load controlled socket) is POWERED ON during weekdays and during work hours. For instance, the second control unit 1002 (also called another plug-load controlled socket) is used for a water cooler 1008, and is configured so that it is POWERED ON intermittently (e.g. for 10 minutes each hour on weekdays and during work hours). For instance, the second control unit 1003 (also called another plug-load controlled socket) is used for a piece of kitchen equipment 1009, and is configured so that it is POWERED ON during weekdays. For instance, the second control unit 1004 (also called another plug-load controlled socket) is used for a laptop 1010, and is configured so that it is POWERED ON during work hours on weekdays and weekends. For instance, the second control unit 1005 (also called another plug-load controlled socket) is used for a humidifier 1011, and is configured so that it is POWERED ON seasonally during off-peak hours. For instance, the second control unit 1006 (also called another plug-load controlled socket) is used for a lamp 1012, and is configured so that it is POWERED ON during weekdays in the evening. These above-mentioned examples of second control unit 104 may either be wall-installed sockets and/or may be distinct units (as shown in FIG. 11) that plug into standard sockets, etc. In accordance with an option, such devices contain a feature 1102 indicating what type of second control unit 104 it is (i.e., what kind of switching logic characterizes the second control unit 104). This indication is made by varying the shape, colour or some other physical aspect of this feature. The first control unit 102 is attached to the common mains wiring in the office 1013 if the first control unit 102 is configured to use the mains as a communication channel with the second control unit 104.

First Control Unit 102 and Second Control Unit 104

According to one option, the first control unit 102 and the second control unit 104 each includes controller-executable instructions configured to operate the first control unit 102 and the second control unit 104 (respectively) in accordance with the description provided above. The first control unit 102 and the second control unit 104 may use computer software, or just software, which is a collection of computer programs (controller-executable instructions) and related data that provide the instructions for instructing the first control unit 102 and the second control unit 104 what to do and how to do it. In other words, software is a conceptual entity that is a set of computer programs, procedures, and associated documentation concerned with the operation of a controller assembly, also called a data-processing system. Software refers to one or more computer programs and data held in a storage assembly (a memory module) of the controller assembly for some purposes. In other words, software is a set of programs, procedures, algorithms and its documentation. Program software performs the function of the program it implements, either by directly providing instructions to computer hardware or by serving as input to another piece of software. In computing, an executable file (executable instructions) causes the first control unit 102 and the second control unit 104 to perform indicated tasks according to encoded instructions, as opposed to a data file that must be parsed by a program to be meaningful. These instructions are machine-code instructions for a physical central processing unit. However, in a more general sense, a file containing instructions (such as bytecode) for a software interpreter may also be considered executable; even a scripting language source file may therefore be considered executable in this sense. While an executable file can be hand-coded in machine language, it is far more usual to develop software as source code in a high-level language understood by humans, or in some cases, an assembly language more complex for humans but more closely associated with machine code instructions. The high-level language is compiled into either an executable machine code file or a non-executable machine-code object file; the equivalent process on assembly language source code is called assembly. Several object files are linked to create the executable. The same source code can be compiled to run under different operating systems, usually with minor operating-system-dependent features inserted in the source code to modify compilation according to the target. Conversion of existing source code for a different platform is called porting. Assembly-language source code and executable programs are not transportable in this way. An executable comprises machine code for a particular processor or family of processors. Machine-code instructions for different processors are completely different and executables are totally incompatible. Some dependence on the particular hardware, such as a particular graphics card may be coded into the executable. It is usual as far as possible to remove such dependencies from executable programs designed to run on a variety of different hardware, instead installing hardware-dependent device drivers on the first control unit 102 and the second control unit 104, which the program interacts with in a standardized way. Some operating systems designate executable files by filename extension (such as .exe) or noted alongside the file in its metadata (such as by marking an execute permission in Unix-like operating systems). Most also check that the file has a valid executable file format to safeguard against random bit sequences inadvertently being run as instructions. Modern operating systems retain control over the resources of the first control unit 102 and the second control unit 104, requiring that individual programs make system calls to access privileged resources. Since each operating system family features its own system call architecture, executable files are generally tied to specific operating systems, or families of operating systems. There are many tools available that make executable files made for one operating system work on another one by implementing a similar or compatible application binary interface. When the binary interface of the hardware the executable was compiled for differs from the binary interface on which the executable is run, the program that does this translation is called an emulator. Different files that can execute but do not necessarily conform to a specific hardware binary interface, or instruction set, can be represented either in bytecode for Just-in-time compilation, or in source code for use in a scripting language.

According to another option, the first control unit 102 and the second control unit 104 includes application-specific integrated circuits configured to operate the first control unit 102 and the second control unit 104 in accordance with the description provided above. It may be appreciated that an alternative to using software (controller-executable instructions) in the first control unit 102 and the second control unit 104 is to use an application-specific integrated circuit (ASIC), which is an integrated circuit (IC) customized for a particular use, rather than intended for general-purpose use. For example, a chip designed solely to run a cell phone is an ASIC. Some ASICs include entire 32-bit processors, memory blocks including ROM, RAM, EEPROM, Flash and other large building blocks. Such an ASIC is often termed a SoC (system-on-chip). Designers of digital ASICs use a hardware description language (HDL) to describe the functionality of ASICs. Field-programmable gate arrays (FPGA) are used for building a breadboard or prototype from standard parts; programmable logic blocks and programmable interconnects allow the same FPGA to be used in many different applications. For smaller designs and/or lower production volumes, FPGAs may be more cost effective than an ASIC design. A field-programmable gate array (FPGA) is an integrated circuit designed to be configured by the customer or designer after manufacturing—hence field-programmable. The FPGA configuration is generally specified using a hardware description language (HDL), similar to that used for an application-specific integrated circuit (ASIC) (circuit diagrams were previously used to specify the configuration, as they were for ASICs, but this is increasingly rare). FPGAs can be used to implement any logical function that an ASIC could perform. The ability to update the functionality after shipping, partial re-configuration of the portion of the design and the low non-recurring engineering costs relative to an ASIC design offer advantages for many applications. FPGAs contain programmable logic components called logic blocks, and a hierarchy of reconfigurable interconnects that allow the blocks to be wired together—somewhat like many (changeable) logic gates that can be inter-wired in (many) different configurations. Logic blocks can be configured to perform complex combinational functions, or merely simple logic gates like AND and XOR. In most FPGAs, the logic blocks also include memory elements, which may be simple flip-flops or more complete blocks of memory. In addition to digital functions, some FPGAs have analog features. The most common analog feature is programmable slew rate and drive strength on each output pin, allowing the engineer to set slow rates on lightly loaded pins that would otherwise ring unacceptably, and to set stronger, faster rates on heavily loaded pins on high-speed channels that would otherwise run too slow. Another relatively common analog feature is differential comparators on input pins designed to be connected to differential signaling channels. A few “mixed signal FPGAs” have integrated peripheral Analog-to-Digital Converters (ADCs) and Digital-to-Analog Converters (DACs) with analog signal conditioning blocks allowing them to operate as a system-on-a-chip. Such devices blur the line between an FPGA, which carries digital ones and zeros on its internal programmable interconnect fabric, and field-programmable analog array (FPAA), which carries analog values on its internal programmable interconnect fabric.

This written description uses examples to disclose the invention, including the best mode, and also to enable any person skilled in the art to make and use the invention. The patentable scope of the invention is defined by the claims, and may include other examples that occur to those skilled in the art. Such other examples are within the scope of the claims if they have structural elements that do not differ from the literal language of the claims, or if they include equivalent structural elements with insubstantial differences from the literal language of the claims.

It may be appreciated that the assemblies and modules described above may be connected with each other as required to perform desired functions and tasks within the scope of persons of skill in the art to make such combinations and permutations without having to describe each and every one in explicit terms. There is no particular assembly, or component that may be superior to any of the equivalents available to the person skilled in art. There is no particular mode of practicing the disclosed subject matter that is superior to others, so long as the functions may be performed. It is believed that all the crucial aspects of the disclosed subject matter have been provided in this document. It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) the description provided outside of this document (that is, outside of the instant application as filed, as prosecuted, and/or as granted). It is understood, for this document, that the phrase “includes” is equivalent to the word “comprising.” The foregoing has outlined the non-limiting embodiments (examples). The description is made for particular non-limiting embodiments (examples). It is understood that the non-limiting embodiments are merely illustrative as examples.

What is claimed is:

1. An apparatus for use with any one of a chargeable electrical device and an electrical device each being configured to be plugged into, and to receive power, from an electrical grid, and the electrical grid being configured to provide electrical energy in accordance with any one of electrical energy pricing and electrical energy availability, and the apparatus comprising:
a first control unit being configured to:
receive and store any one of the electrical energy pricing and the electrical energy availability associated with the electrical energy provided by the electrical grid; and
transmit a signal having, at least in part, any one of the electrical energy pricing, the electrical energy availability and the time-of-day; and
a second control unit being configured to:
be electrically connected to the electrical grid; and
be electrically connected to any one of the chargeable electrical device and the electrical device; and
receive the signal being transmitted by the first control unit; and
electrically connect any one of the chargeable electrical device and the electrical device with the electrical grid in such a way as to permit the electrical grid to any one of (A) charge the chargeable electrical device and (B) operate the electrical device for a case where the signal that was received from the first control unit indicates that any one of a cost of electricity is relatively lower and electricity is more available so that the second control unit is urged to power ON any one of the chargeable electrical device and the electrical device; and
electrically disconnect any one of the chargeable electrical device and the electrical device from the electrical grid in such a way that any one of the chargeable electrical device and the electrical device no longer receives the electrical energy from the electrical grid for the case where the signal that was received from the first control unit indicates that any one of the cost of electricity is relatively higher and electricity is less available so that the second control unit is urged to power OFF any one of the chargeable electrical device and the electrical device.

2. The apparatus of claim 1, wherein:
the first control unit and the second control unit each includes:
a processor assembly;
a memory assembly operatively connected to the processor assembly, and the memory assembly being configured to tangibly store executable programmed instructions configured to urge the processor assembly to execute predetermined operations);
an input module; and
an output module.

3. The apparatus of claim 2, wherein:
the executable programmed instructions of the first control unit are configured to:
receive and read the signal representing the cost of electricity;
store the signal representing the cost of electricity to the memory assembly of the first control unit; and
transmit the signal representing the cost of electricity to the second control unit.

4. The apparatus of claim 3, wherein:
the executable programmed instructions of the second control unit are configured to:
receive and read the signal representing the cost of electricity that is provided from the first control unit;
store the signal representing the cost of electricity to the memory assembly of the second control unit;
analyse the signal representing the cost of electricity;
provide a control ON/OFF signal, in response to the signal representing the cost of electricity; and
control operation of any one of the chargeable electrical device and the electrical device based on the control ON/OFF signal that was computed.

5. The apparatus of claim 3, wherein:
the second control unit is configured to receive, from the first control unit, the signal corresponding to any one of the electrical energy pricing and the electrical energy availability associated with the electrical energy.

6. The apparatus of claim 3, wherein:
the second control unit is configured to switch ON/OFF any one of the electrical device and the chargeable electrical device based on any one of the electrical energy pricing and the electrical energy availability.

7. The apparatus of claim 3, wherein:
a control command signal that is issued by the first control unit to the second control unit indicates any one of the electrical energy that costs relatively less and the electrical energy that costs relatively more; and
the second control unit receives the control command signal from the first control unit, and then the second control unit translates the control command signal, provided by the first control unit, into a control ON/OFF signal.

8. The apparatus of claim 3, wherein:
the second control unit is also configured to connect any one of the chargeable electrical device and the electrical device with the electrical grid in such a way as to permit the electrical grid to any one of (A) charge the chargeable electrical device and (B) operate the electrical device, for the case where the signal provides an indication that any one of the cost of electricity is relatively lower and electricity is more available, and as a result of any one of the electrical energy pricing and the electrical energy availability, a control command indicates to power ON any one of the chargeable electrical device and operate the electrical device.

9. The apparatus of claim 3, wherein:
the second control unit is also configured to disconnect any one of the chargeable electrical device and the electrical device from the electrical grid in such a way that any one of the chargeable electrical device and the electrical device no longer receives the electrical energy from the electrical grid, for the case where the signal from the first control unit indicates that the cost of electricity is any one of relatively higher and electricity is less available, and as a result, a control command indicates to power OFF any one of the chargeable electrical device and the electrical device.

10. The apparatus of claim 3, wherein:
the first control unit is configured to transmit the signal related to any one of the electrical energy pricing, the electrical energy availability and the time-of-day to the second control unit;
the second control unit is configured to receive the signal from the first control unit; and
the first control unit is configured to identify a current time of day and to receive and store any one of the electrical energy pricing and electricity availability.

11. The apparatus of claim 1, wherein:
any one of the electrical energy pricing and electricity availability includes any one of:
a number of discrete electricity price levels of electricity for any given calendar date and time of day; and
a real-time price of electricity based on a current balance of demand and supply.

12. The apparatus of claim 3, wherein:
the first control unit is configured to be linked to additional information sources, both internal or external to the first control unit, including any one of a timer, a home occupancy sensor, a smoke detector, a smoke alarm that allow an informed decision on when to apply plug load control.

13. The apparatus of claim 3, wherein:
information is stored in the first control unit, and relies on pre-determined cyclical variations of any one of the electrical energy pricing and electricity availability.

14. The apparatus of claim 3, wherein:
the first control unit is configured to any one of:
gather information, on a PULL basis, from an information source; and
receive information, on a PUSH basis, from the information source.

15. The apparatus of claim 3, wherein:
the first control unit is configured to:
receive any one of the electrical energy pricing and electricity availability;
store any one of the electrical energy pricing and electricity availability; and
broadcast any one of the electrical energy pricing and electricity availability via the signal that corresponds to any one of the electrical energy pricing, the electrical energy availability and the time-of-day.

16. The apparatus of claim 3, wherein:
the second control unit is configured to receive and interpret the signal provided by the first control unit;
the second control unit is configured to control a controllable switch; and
the controllable switch is configured to route electrical power to any one of the chargeable electrical device and the electrical device that is operatively attached to the controllable switch.

17. The apparatus of claim 3, wherein:
the second control unit is configured to use a plurality of switching profiles to determine whether to connect or disconnect any one of the chargeable electrical device and the electrical device based on the signal related to any one of the electrical energy pricing and electricity availability and the time-of-day provided by the first control unit along with control logic of the second control unit reading the signal from the first control unit and then as a result providing a control signal configured to control connection and disconnection of electrical power to any one of the electrical device and the chargeable electrical device.

18. The apparatus of claim 3, wherein:
a switching profile is characterized by a set of switching rules that specify cases when the second control unit is any one of powered ON and powered OFF.

19. The apparatus of claim 3, wherein:
the second control unit includes a different switching profile, depending on usage of the second control unit.

20. The apparatus of claim 3, wherein:
the second control unit includes a manual override button configured to allow a user to close a controllable switch, and continuously provide power to any one of the chargeable electrical device and the electrical device; and
the manual override button is configured to be any one of manually released and released upon a predetermined event.
